(19) United States
(12) Patent Application Publication
(10) Pub. No.: US 2015/0156164 A1
(43) Pub. Date: Jun. 4, 2015

(54) COMMUNICATION SYSTEM, COMMUNICATION CONTROL METHOD, COMMUNICATION RELAY SYSTEM, AND COMMUNICATION RELAY CONTROL METHOD

(71) Applicant: NEC Corporation, Tokyo (JP)

(72) Inventor: Yusei Sekitani, Tokyo (JP)

(73) Assignee: NEC CORPORATION, Tokyo (JP)

(21) Appl. No.: 14/402,407

(22) PCT Filed: May 15, 2013
(86) PCT No.: PCT/JP2013/003085

§ 371 Date: Nov. 20, 2014

(30) Foreign Application Priority Data
Jun. 6, 2012 (JP) 2012-128746

(51) Int. Cl. H04L 29/12

(52) U.S. Cl. CPC H04L 61/2007; H04L 61/6068

(57) ABSTRACT

A communication system 1000 includes a plurality of information processing devices and a communication relay system relaying transmission of a packet between each of the plurality of information processing devices and an external device. At least one same IP address is assigned to each of the plurality of information processing devices. The communication system 1000 includes a transmission destination setting part 1001 configured to set one of the plurality of information processing devices, as the destination of transmission of a packet with the IP address set as a destination. The communication relay system includes a packet transferring part 1002 configured to, when receiving a packet with the IP address set as a destination from the external device, transmit the received packet to the set destination of transmission.

### TECHNICAL FIELD

The present invention relates to a communication system which includes a plurality of information processing devices and a communication relay system relaying transmission of a packet between each of the information processing devices and an external device.

### BACKGROUND ART

There is a known communication system which includes a plurality of information processing devices and a communication relay system relaying transmission of a packet between each of the information processing devices and an external device. In this type of communication system, IP addresses assigned to the respective information processing devices are different from each other.

Upon receiving a packet in which a certain IP address is set as the destination from an external device, the communication relay system transmits the packet to an information processing device to which the IP address is assigned. Therefore, in order to change an information processing device with which the external device exchanges packets, there is a need to change an IP address set as the destination of a packet by the external device.

Therefore, for example, a communication system disclosed in Patent Document 1 uses DNS (Domain Name System). In this communication system, a DNS server stores a table in which host names or domain names assigned to information processing devices are associated with IP addresses. A client terminal as an external device acquires an IP address associated with a host name or a domain name from the DNS server.

Then, the client terminal transmits a packet in which the acquired IP address is set as the destination, to the communication system. Therefore, in this communication system, by changing the table stored by the DNS server, it is possible to change an information processing device with which the external device exchanges packets.
Patent Document 1: Japanese Unexamined Patent Application Publication No. 2007-243564

In the communication system, information representing pairs of host names or domain names and IP addresses is held by a cache device (e.g., a cache server) other than the DNS server. Then, when the external device acquires an IP address, there is a case where the information held by the cache device is used.

Therefore, it takes a relatively long delay time before an information processing device with which the external device exchanges packets is actually changed after the table stored by the DNS server is changed. In other words, it is impossible to speedily change an information processing device with which the external device exchanges packets. Consequently, there is a problem that a service provided by a server device as the information processing device to a client terminal as the external device halts, for example.

### SUMMARY

Accordingly, an object of the present invention is to provide a communication system which is capable of solving the abovementioned problem, “there is a case where it is impossible to speedily change an information processing device with which an external device exchanges packets.”

In order to achieve the object, a communication system as an aspect of the present invention is a system including a plurality of information processing devices and a communication relay system relaying transmission of a packet between each of the plurality of information processing devices and an external device.

Moreover, at least one same IP address is assigned to each of the plurality of information processing devices.

Besides, the communication system includes a transmission destination setting means for setting one of the plurality of information processing devices, as a destination of transmission of a packet with the IP address set as a destination,

The communication relay system includes a packet transferring means for, when receiving a packet with the IP address set as a destination from the external device, transmitting the received packet to the set destination of transmission.

Further, a communication control method as another aspect of the present invention is a method applied to a communication system including a plurality of information processing devices and a communication relay system relaying transmission of a packet between each of the plurality of information processing devices and an external device.

Moreover, this communication control method is a method including:

assigning at least one same IP address to each of the plurality of information processing devices; and

setting one of the plurality of information processing devices, as a destination of transmission of a packet with the IP address set as a destination,

wherein, when the communication relay system receives a packet with the IP address set as a destination from the external device, the communication relay system transmits the received packet to the set destination of transmission.

Further, a communication relay system as another aspect of the present invention is a system relaying transmission of a packet between each of a plurality of information processing devices and an external device.

Moreover, at least one same IP address is assigned to each of the plurality of information processing devices.

Besides, the communication relay system includes:

a transmission destination setting means for setting one of the plurality of information processing devices, as a destination of transmission of a packet with the IP address set as a destination; and

a packet transferring means for, when receiving a packet with the IP address set as a destination from the external device, transmitting the received packet to the set destination of transmission.

Further, a communication relay control method as another aspect of the present invention is a method applied to a communication relay system relaying transmission of a packet between each of a plurality of information processing devices and an external device.

Moreover, this communication relay control method is a method including:

assigning at least one same IP address to each of the plurality of information processing devices;

setting one of the plurality of information processing devices, as a destination of transmission of a packet with the IP address set as a destination; and

when receiving a packet with the IP address set as a destination from the external device, transmitting the received packet to the set destination of transmission.

With the configurations as described above, the present invention makes it possible to speedily change an information processing device which a packet with a certain IP address set as the destination reaches.

### BRIEF DESCRIPTION OF DRAWINGS

FIG. 1 is a diagram showing a schematic configuration of a communication system according to a first exemplary embodiment of the present invention;

FIG. 2 is a block diagram showing the function of a communication relay device according to the first exemplary embodiment of the present invention;

FIG. 3 is a block diagram showing the function of a management device according to the first exemplary embodiment of the present invention;

FIG. 4 is a block diagram showing the function of a server device according to the first exemplary embodiment of the present invention;

FIG. 5 is a sequence diagram showing the operation of the communication system according to the first exemplary embodiment of the present invention;

FIG. 6 is a sequence diagram showing the operation of the communication system according to the first exemplary embodiment of the present invention;

FIG. 7 is a sequence diagram showing the operation of a communication system according to a second exemplary embodiment of the present invention;

FIG. 8 is a sequence diagram showing the operation of the communication system according to the second exemplary embodiment of the present invention;

FIG. 9 is a sequence diagram showing the operation of a communication system according to a third exemplary embodiment of the present invention; and

FIG. 10 is a block diagram showing the configuration of a communication system according to a fourth exemplary embodiment of the present invention.

### EXEMPLARY EMBODIMENTS

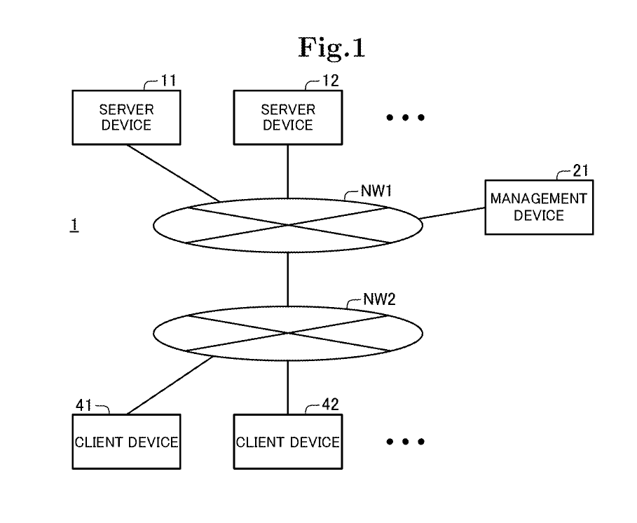

Below, the respective exemplary embodiments of a communication system, a communication control method, a communication relay system and a communication relay control method will be described referring to FIGS. 1 to 10.

### First Exemplary Embodiment

### (Configuration)

As shown in FIG. 1, a communication system 1 according to a first exemplary embodiment includes a plurality of server devices (information processing devices) 11, 12, . . . and a management device 21. The server devices 11, 12, . . . and the management device 21 are connected so as to be capable of mutually communicating via a server communication network NW1 configuring an IP (Internet Protocol) network.

The server communication network NW1 is configured by at least one communication relay device such as a switch device and a router device (in this exemplary embodiment, a plurality of communication relay devices).

A plurality of client devices (external devices) 41, 42, . . . are connected to the server communication network NW1 so as to be capable of mutually communicating via a client communication network NW2 configuring an IP network. The client communication network NW2 is configured by at least one communication relay device such as a switch device and a router device (in this exemplary embodiment, a plurality of communication relay devices).

The management device 21 and the communication relay devices configuring the server communication network NW1 configure a communication relay system which relays transmission of a packet between each of the server devices 11, 12, . . . and each of the client devices 41, 42, . . . . In this exemplary embodiment, the communication relay system is a system compliant with Open Flow described in Non-Patent Document 1.
Non-Patent Document 1: “OpenFlow Specification, Version 1.2” [online], December 2011, Open Networking Foundation [searched on May 16, 2012”<URL: https//www.opennetworking.org/images/stories/downloads/openflow/openflow-spec-v1.2.pdf>

The server devices 11, 12, . . . and the management device 21 each include a central processing unit (CPU) and a storage device (a memory and a hard disk drive (HDD)), which are not shown in the drawings.

The server devices 11, 12, . . . and the management device 21 are each configured to realize a function to be described later by the CPU's execution of a program stored in the storage device. Each of the functions of the server devices 11, 12, . . . and the management device 21 may be realized by hardware such as a circuit.

Each of the client devices 41, 42, . . . is a personal computer. Each of the client devices 41, 42, . . . may be a mobile phone terminal, a PHS (Personal Handyphone System), a PDA (Personal Data Assistance, Personal Digital Assistant), a smartphone, a car navigation terminal, a game terminal, or the like.

The client devices 41, 42, . . . each include a central processing unit (CPU), a storage device (a memory and a hard disk drive (HDD)), an input device (in this exemplary embodiment, a keyboard and a mouse), and an output device (in this exemplary embodiment, a display).

The client devices 41, 42, . . . are each configured to realize a function to be described later by the CPU's execution of a program stored in the storage device. The function of each of the client devices 41, 42, . . . may be realized by hardware such as a circuit.

In this exemplary embodiment, the respective server devices 11, 12, . . . and the respective client devices 41, 42, . . . are configured to communicate in accordance with SIP (Session Initiation Protocol). In other words, each of the server devices 11, 12, . . . configures an SIP server. The respective server devices 11, 12, . . . and the respective client devices 41, 42, . . . may be configured to communicate in accordance with a communication system other than SIP.

The same set of IP addresses is assigned to each of the server devices 11, 12, . . . . In this exemplary embodiment, a set of IP addresses is composed of a plurality of (in this exemplary embodiment, two) different IP addresses. To be specific, a set of IP addresses is composed of a first IP address IP1 and a second IP address IP2.

A set of IP addresses may be composed of only one IP address. Besides, an IP address other than the set of IP addresses may be further assigned to each of the server devices 11, 12, . . . .

### (Function)

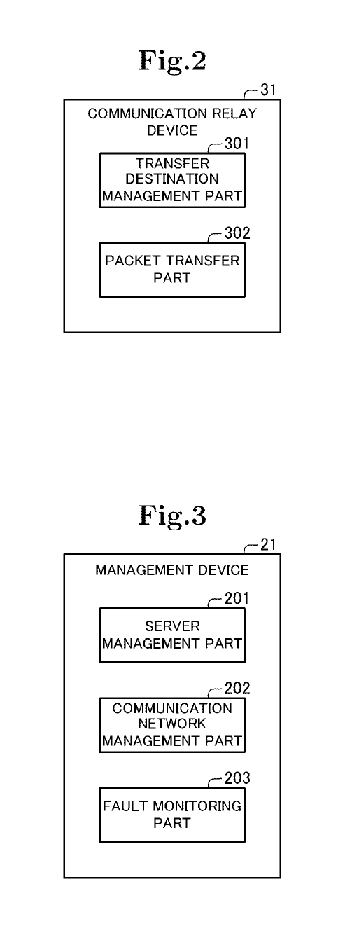

FIG. 2 is a block diagram showing the function of a communication relay device 31 configuring the server communication network NW1. This function is realized by hardware such as a circuit. Meanwhile, this function may be realized by execution of a program by a CPU included by the communication relay device 31.

The function of the communication relay device 31 includes a transfer destination management part (part of a transmission destination setting means) 301 and a packet transfer part (a packet transmitting means) 302.

The transfer destination management part 301 holds (stores) communication flow specification information for specifying a communication flow and transfer destination specification information for specifying a device (a communication relay device or a server device) to which the communication flow is to be transferred in association with each other.

A communication flow (a traffic flow) is a set of communication traffic specified by any combination of an address/identifier of each of the physical layer (a first layer, L1), the data link layer (a second layer, L2), the network layer (a third layer, L3) and the transport layer (a fourth layer, L4) in the OSI (Open Systems Interconnection) Reference Model. Communication traffic is unit data (in this exemplary embodiment, a packet) having a predetermined format.

For example, a communication flow may be a set of communication traffic specified by any combination of a MAC (Medium Access Control) address, an IP address, a port number, and data as payload.

The transfer destination management part 301 receives communication network control information transmitted by the management device 21 as described later. Communication network control information is information for updating (adding, changing or deleting) the communication flow specification information and transfer destination specification information held by the transfer destination management part 301. The transfer destination management part 301 updates the communication flow specification information and transfer destination specification information held thereby, based on the communication network control information received thereby.

The packet transfer part 302 receives a packet from another device (the communication relay device 31, or the server device 11, 12, . . . ). The packet transfer part 302 determines the destination of transfer of the packet received thereby, based on the communication flow specification information and transfer specification information held by the transfer destination management part 301. In other words, the packet transfer part 302 specifies a device specified by transfer specification information stored in association with communication flow specification information for specifying a communication flow configured by the received packet, as the destination of transfer of the packet.

Then, the packet transfer part 302 transmits (transfers) the received packet to the specified transfer destination. In other words, it can be said that each of the communication relay devices 31 configuring the server communication network NW1 configures a packet transferring means which, upon receiving a packet in which an IP address is set as the destination from the client device 41, 42, . . . , transmits the received packet to the set transmission destination.

As shown in FIG. 3, the function of the management device 21 includes a service management part 201, a communication network management part (part of the transmission destination setting means) 202, and a fault monitoring part 203.

The service management part 201 transmits a sharing instruction for instructing to share process continuing information among the server devices 11, 12, . . . , to each of the server devices 11, 12, . . . .

Process continuing information is information for continuing a process based on a packet transmitted between the server device 11, 12, . . . and the client device 41, 42, . . . (in this exemplary embodiment, a process for providing a service from the server device 11, 12, . . . to the client device 41, 42, . . . ). For example, process continuing information contains data as payload contained in a packet, a sequence number for verifying the continuity of the packet, information for identifying a process, and so on. Moreover, a sharing instruction contains sharing server specification information for specifying each of the server devices 11, 12, . . . where the sharing instruction is to be transmitted.

In this exemplary embodiment, the service management part 201 transmits a sharing instruction to the server device (a first server device) 11 and the server device (a second server device) 12, respectively. The service management part 201 may be configured to transmit a sharing instruction to three of more server devices 11, 12, . . . , respectively.

The service management part 201 stores sharing server specification information for specifying each of the server devices 11, 12, . . . where a sharing instruction is to be transmitted.

Further, the service management part 201 holds (stores) provision source specification information for specifying the server device 11, 12, . . . that is the source of provision of a service being provided currently, and provision destination specification information for specifying the client device 41, 42, . . . that is the destination of provision of the service, in association with each other.

The service management part 201 receives service state information transmitted by the server device 11, 12, . . . as described later. Service state information is information for updating (adding, changing or deleting) the provision source specification information and provision destination specification information held by the service management part 201. The service management part 201 updates the provision source specification information and provision destination specification information held thereby, based on the service state information received thereby.

Further, when the fault monitoring part 203 to be described later detects occurrence of a fault in the server device (the first server device) 11 as the source of provision of a service being provided currently, the service management part 201 transmits a process continuing instruction to the server device (the second server device) 12 where occurrence of a fault is not detected among the server devices that share the process continuing information with the first server device 11. A process continuing instruction is information for instructing to continue a process based on a packet transmitted between the server device 11, 12, . . . and the client device 41, 42, . . . based on process continuing information.

The communication network management part 202 firstly transmits communication network control information to each of the communication relay devices configuring the server communication network NW1 so as to set the first server device 11 as the destination of transmission of a packet (a communication flow) in which the first IP address IP1 is set as the destination. Moreover, the communication network management part 202 transmits communication network control information to each of the communication relay devices configuring the server communication network NW1 so as to set the second server device 12 as the destination of transmission of a packet in which the second IP address IP2 is set as the destination.

Thus, the communication network management part 202 is configured to, for each of a plurality of IP addresses, set one of the server devices 11, 12, . . . that the IP address is assigned, as the destination of transmission of a packet in which the IP address is set as the destination.

According to this, it is possible to, for each of a plurality of IP addresses, appropriately transmit a packet with the IP address set as the destination to the server device 11, 12, . . . .

After that, when occurrence of a fault is detected in the server device (the first server device) 11 as the source of provision of the service being provided currently, the communication network management part 202 switches the destination of transmission of the packet to the second server device 12. To be specific, the communication network management part 202 transmits communication network control information to each of the communication relay devices configuring the server communication network NW1 so as to set the second server device 12 as the destination of transmission of a packet in which the first IP address IP1 is set as the destination.

The fault monitoring part 203 monitors occurrence of a fault in each of the server devices 11, 12, . . . . In this exemplary embodiment, the fault monitoring part 203 transmits a predetermined fault monitoring signal to each of the server devices 11, 12, . . . every time a preset monitoring period passes.

Then, in the case of receiving a response signal for responding to the fault monitoring signal from the server device 11, 12, . . . , the fault monitoring part 203 judges that a fault is not occurring in the server device 11, 12, . . . (does not detect occurrence of a fault). On the other hand, in the case of not receiving a response signal from the server device 11, 12, . . . , the fault monitoring part 203 judges that a fault is occurring in the server device 11, 12, . . . (detects occurrence of a fault).

In a case where the server devices 11, 12, . . . are each configured to transmit a predetermined normality notification signal every time a preset transmission period passes, it is favorable that the fault monitoring part 203 is configured to, without transmitting a fault monitoring signal, monitor occurrence of a fault based on the presence of reception of the normality notification signal.

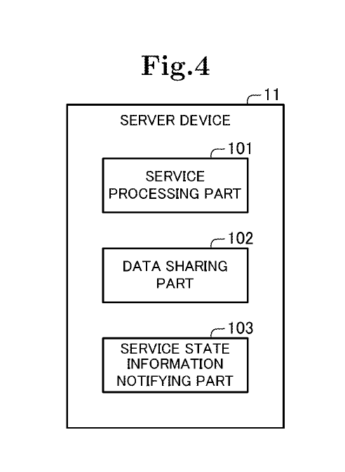

As shown in FIG. 4, the function of the server device 11 includes a service processing part (a response-time transmission source setting means) 101, a data sharing part (a process continuing information transmitting means) 102, and a service state information notifying part 103. The server devices 12, . . . other than the server device 11 also include the same function.

The service processing part 101 executes a process based on a packet transmitted between the server device 11 and the client device 41, 42, . . . (in this exemplary embodiment, a process for providing a service from the server device 11 to the client device 41, 42, . . . (a service process)). For example, upon receiving a service start request from the client device 41, 42, . . . , the service processing part 101 starts to execute a service process for the client device.

The service processing part 101 is configured to, while executing a service process, set an IP address set as the destination of a packet received from the client device 41, 42, . . . , as the source of transmission of a packet to be transmitted to the client device 41, 42, . . . in order to respond to the received packet.

For example, by using the bind function installed in the OS (Operating System), the service processing part 101 acquires an IP address set as the destination of the received packet. Moreover, by using RawSocket, the service processing part 101 generates a packet with the acquired IP address set as the destination of transmission.

According to this, it is possible to securely exchange packets between the client device 41, 42, . . . and the server device 11, 12, . . . . In other words, it is possible to appropriately perform communication between the client device 41, 42, . . . and the server device 11, 12, . . . .

While executing a service process, the service processing part 101 holds process continuing information for continuing the service process.

In the case of receiving a process continuing instruction from the management device 21, the service processing part 101 continues a service process based on process continuing information stored by the data sharing part 102 to be described later.

In the case of receiving a sharing instruction from the management device 21, the data sharing part 102 transmits/receives process continuing information so as to share the process continuing information with the other server devices 12, . . . specified by sharing server specification information contained in the sharing instruction.

According to this, in a case where the destination of transmission of a packet is changed from the first server device 11 to the second server device 12, the second server device 12 can continue executing a process having been executed by the first server device 11. Therefore, it is possible to avoid that a service provided from the server device 11, 12, . . . to the client device 41, 42, . . . halts.

To be specific, the data sharing part 102 transmits process continuing information relating to a service process being executed by the own device (the server device 11), to the other server device. Moreover, the data sharing part 102 receives process continuing information relating to a service process being executed by the other server device from the other server device, and stores the received process continuing information.

In this exemplary embodiment, the data sharing part 102 is configured to, after receiving a sharing instruction, transmit process continuing information relating to a service process being executed by the own device to the other server device 12, . . . every time a preset updating period passes. Meanwhile, the data sharing part 102 may be configured to, after receiving a sharing instruction, every time process continuing information relating to a service process being executed by the own device is changed, transmit the process continuing information to the other server device 12, . . . .

According to this, even when a fault occurs in the first server device 11, the second server device 12 can continue executing a process having been executed by the first service device 11 by using process continuing information already transmitted thereto.

The service state information notifying part 103 transmits service state information to the management device 21 when execution of a service process is started, when execution of a service process is ended, and when a service process is continued.

### (Operation)

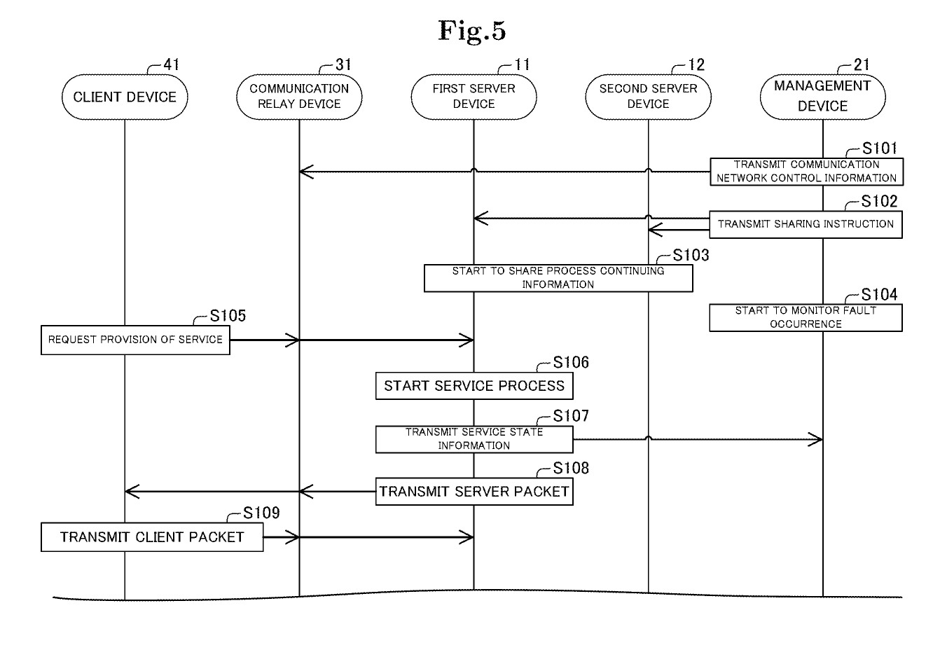

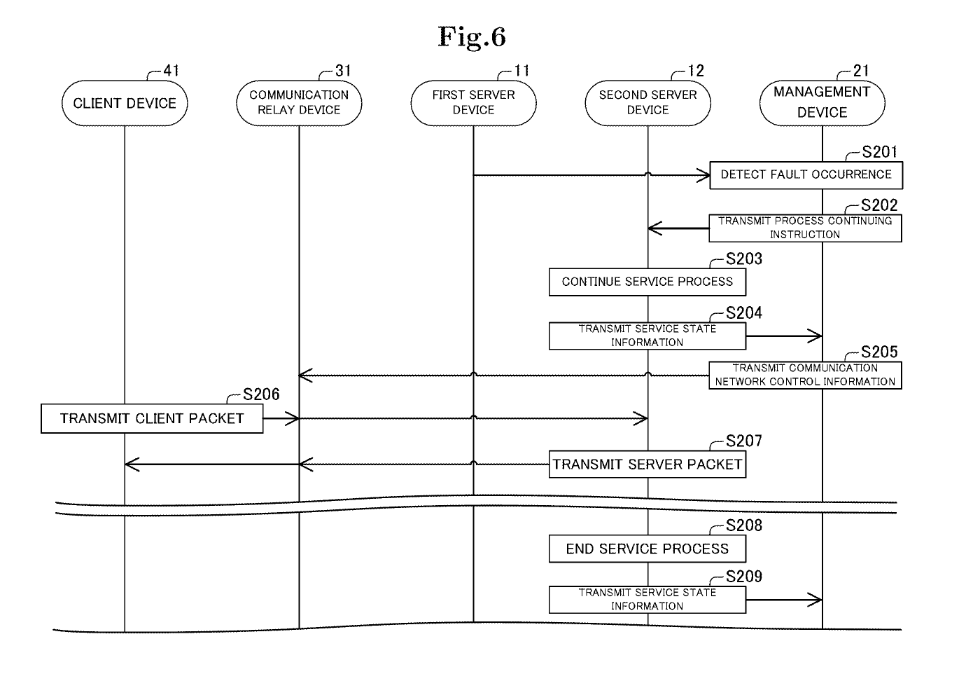

Next, the operation of the abovementioned communication system 1 will be described referring to FIGS. 5 and 6.

First, the management device 21 transmits communication network control information to each of the communication relay devices 31 configuring the server communication network NW1 so as to set the first server device 11 as the destination of transmission of a packet in which the first IP address IP1 is set as the destination.

Further, the management device 21 transmits communication network control information to each of the communication relay devices 31 configuring the server communication network NW1 so as to set the second server device 12 as the destination of transmission of a packet in which the second IP address IP2 is set as the destination (step S101 in FIG. 5).

Thus, when receiving a packet which is transmitted by the client device 41, 42, . . . and in which the first IP address IP1 is set as the destination, each of the communication relay devices 31 configuring the server communication network NW1 transmits the packet to the first server device 11. Likewise, when receiving a packet which is transmitted by the client device 41, 42, . . . and in which the second IP address IP2 is set as the destination, each of the communication relay devices 31 configuring the server communication network NW1 transmits the packet to the second server device 12.

Next, the management device 21 transmits a sharing instruction to each of the first and second server devices 11 and 12 (step S102 in FIG. 5). A sharing instruction contains sharing server specification information for specifying each of the first and second server devices 11 and 12.

Thus, the first server device and the second server device 12 starts to share process continuing information between the first server device 11 and the second server device 12 (step S103 in FIG. 5). To be specific, every time a preset update period passes, each of the first and second server devices 11 and 12 transmits process continuing information relating to a service process being executed by the device itself to the other server device. Each of the first and second server devices 11 and 12 stores the process continuing information received thereby.

Next, the management device 21 starts to monitor occurrence of a fault (fault occurrence) in each of the first and second server devices 11 and 12 (step S104 in FIG. 5).

To be specific, every time a preset monitoring period passes, the management device 21 transmits a predetermined fault monitoring signal to each of the first and second server devices 11 and 12. Then, based on whether or not the management device 21 has received a response signal for responding to the fault monitoring signal from each of the first and second server devices 11 and 12, the management device 21 judges whether or not a fault has occurred.

After that, the client device 41 requests provision of a service (step S105 in FIG. 5). To be specific, the client device 41 transmits a packet which represents a request for provision of a service, in which the first IP address IP1 is set as the destination, and in which an IP address assigned to the client device 41 is set as the source of transmission.

Thus, one of the communication relay devices 31 configuring the server communication network NW1 receives the packet transmitted from the client device 41. Then, the respective communication relay devices 31 configuring the server communication network NW1 transmit the packet toward the first server device 11.

Thus, the first server device 11 starts to execute a process for providing a service to the client device 41 (a service process) (step S106 in FIG. 5). Next, the first server device 11 transmits service state information to the management device 21 (step S107 in FIG. 5). This service state information is information for causing the management device 21 to newly hold provision source specification information for specifying the first server device 11 and provision destination specification information for specifying the client device 41.

After that, the first server device 11 transmits a server packet (step S108 in FIG. 5). This server packet is a packet transmitted to the client device 41 to respond to the packet received by the first server device 11 from the client device 41. That is, this server packet is a packet in which the first IP address IP1 is set as the transmission source and the IP address assigned to the client device 41 is set as the destination.

The respective communication relay devices 31 configuring the server communication network NW1 transmit the server packet toward the client device 41 via the client communication network NW2.

After that, the client device 41 transmits a client packet (step S109 in FIG. 5). This client packet is a packet in which the first IP address IP1 is set as the destination and the IP address assigned to the client device 41 is set as the transmission source.

The respective communication relay devices 31 configuring the server communication network NW1 transmit the client packet toward the first server device 11.

After that, the same process as in steps S108 and S109 is repeatedly executed, whereby a service is provided from the first server device 11 to the client device 41. As described above, while executing a service process (while providing a service), the first server device 11 updates process continuing information held thereby, and transmits the updated process continuing information to the second server device 12.

A case where a fault occurs afterward in the first server device 11 during execution of the service process will be assumed. In this case, the management device 21 detects occurrence of a fault in the first server device 11 (step S201 in FIG. 6).

Next, the management device 21 transmits a process continuing instruction to the second server device 12 where occurrence of a fault is not detected among the server devices that share the process continuing information with the first server device 11 (step S202 in FIG. 6).

Thus, the second server device 12 continues the service process that the first server device 11 has executed to provide the service to the client device 41, based on the process continuing information received thereby from the first server device 11 (step S203 in FIG. 6).

Then, the second server device 12 transmits service state information to the management device 21 (step S204 in FIG. 6). This service state information is information for changing the provision source specification information held by the management device 21 in association with the provision destination specification information for specifying the client device 41, to provision source specification information for specifying the second server device 12.

Next, the management device 21 transmits communication control information to each of the communication relay devices 31 configuring the server communication network NW1 so as to set the second server device 12 as the destination of a packet in which the first IP address IP1 is set as the destination (step S205 in FIG. 6).

Thus, when receiving a packet which is transmitted by the client device 41, 42, . . . and in which the first IP address IP1 is set as the destination, each of the communication relay devices 31 configuring the server communication network NW1 transmits the packet toward the second server device 12.

After that, the client device 41 transmits a client packet (step S206 in FIG. 6). This client packet is a packet in which the first IP address IP1 is set as the destination and the IP address assigned to the client device 41 is set as the transmission source.

The respective communication relay devices 31 configuring the server communication network NW1 transmit the client packet toward the second server device 12.

Then, the second server device 12 transmits a server packet (step S207 in FIG. 6). This server packet is a packet transmitted to the client device 41 to respond to the packet received by the second server device 12 from the client device 41. That is, this server packet is a packet in which the first IP address IP1 is set as the transmission source and the IP address assigned to the client device 41 is set as the destination.

The respective communication relay devices 31 configuring the server communication network NW1 transmit the server packet toward the client device 41 via the client communication network NW2.

After that, the same process as in steps S206 and S207 is repeatedly executed, whereby a service is provided from the second server device 12 to the client device 41.

After that, the second server device 12 ends execution of the service process (step S208 in FIG. 6). Next, the second server device 12 transmits service state information to the management device 21 (step S209 in FIG. 6). This service state information is information for deleting the provision source specification information for specifying the second server device 12 and the client device 41 that are held by the management device 21.

As described above, according to the communication system 1 of the first exemplary embodiment of the present invention, it is possible to speedily change the server device 11, 12, . . . where a packet in which a certain IP address (in this exemplary embodiment, the first IP address IP1) assigned to the plurality of server devices 11, 12, . . . is set as the destination reaches.

Consequently, it is possible, without changing the destination of a packet transmitted by the client device 41, to speedily change the server device 11, 12, . . . that the client device 41 exchanges packets (in this exemplary embodiment, change from the first server device 11 to the second server device 12). As a result, it is possible, without halting a service provided to the client device 41, to change the server device 11, 12, . . . that provides the service.

Therefore, for example, in a case where a fault occurs in the first server device 11, it is possible, without halting a service provided to the client device 41, to change a server device that provides the service to the second server device 12. Moreover, it is also possible to easily increase or decrease server devices that provide a service.

Further, for example, in the case of regularly maintaining the first server device 11, in the case of replacing a part of the first server device 11, or in the case of updating a program held by the first server device 11 to execute, it is possible, without halting a service provided to the client device 41, to change a server device that provides the service to the second server device 12. Moreover, it is also possible, without halting the service provided to the client device 41, to change a server device that provides the service back to the first server device 11 afterward.

Besides, a communication relay system according to a modified example of the first exemplary embodiment may be configured to control the destination of transmission of a packet with a certain IP address set as the destination, in accordance with a system other than OpenFlow.

The communication system 1 according to another modified example of the first exemplary embodiment may be configured to, while changing the server device 11, 12, . . . that is the destination of transmission of a packet (e.g., until the communication relay device 31 receives communication network control information after the management device 21 detects occurrence of a fault), stop transfer of a packet by the communication relay devices 31 configuring the server communication network NW1.

According to this, it is possible to avoid missing of a packet (occurrence of packet loss) in the server communication network NW1.

### Second Exemplary Embodiment

Next, a communication system according to a second exemplary embodiment of the present invention will be described. The communication system according to the second exemplary embodiment is different from the communication system according to the first exemplary embodiment in that, when a server device as the destination of transmission of a packet is changed, the communication system according to the second exemplary embodiment transmits process continuing information from a server device before the change to a server device after the change. Therefore, a description will be made below focusing on the different point.

### (Function)

The function of the management device 21 according to the second exemplary embodiment does not include the fault monitoring part 203. Meanwhile, the function of the management device 21 may include the fault monitoring part 203.

The service management part 201 according to the second exemplary embodiment transmits a change instruction to the server device 11, 12, . . . as a preset source of change when a preset change time and date comes. A change instruction contains change destination specification information for specifying the server device 11, 12, . . . as the destination of change. The service management part 201 may be configured to transmit a change instruction based on input of information by the user of the management device 21 (e.g., the manager of the communication system 1).

The data sharing part 102 according to the second exemplary embodiment transmits process continuing information held thereby to a server device specified by change destination specification information contained in a change instruction, only when receiving the change instruction from the management device 21.

Further, when receiving process continuing information from the other server device, the data sharing part 102 stores the process continuing information. In addition, the service processing part 101 according to the second exemplary embodiment continues a service process based on the process continuing information stored by the data sharing part 102.

Thus, the communication system 1 according to the second exemplary embodiment is configured to, in a case where the destination of transmission of a packet set by the communication network management part 202 is changed from the first server device 11 to the second server device 12, transmit process continuing information from the first server device 11 to the second server device 12.

According to this, it is possible to avoid that a load required to transmit process continuing information (e.g., a communication load, a processing load, etc.) is wastefully produced.

### (Operation)

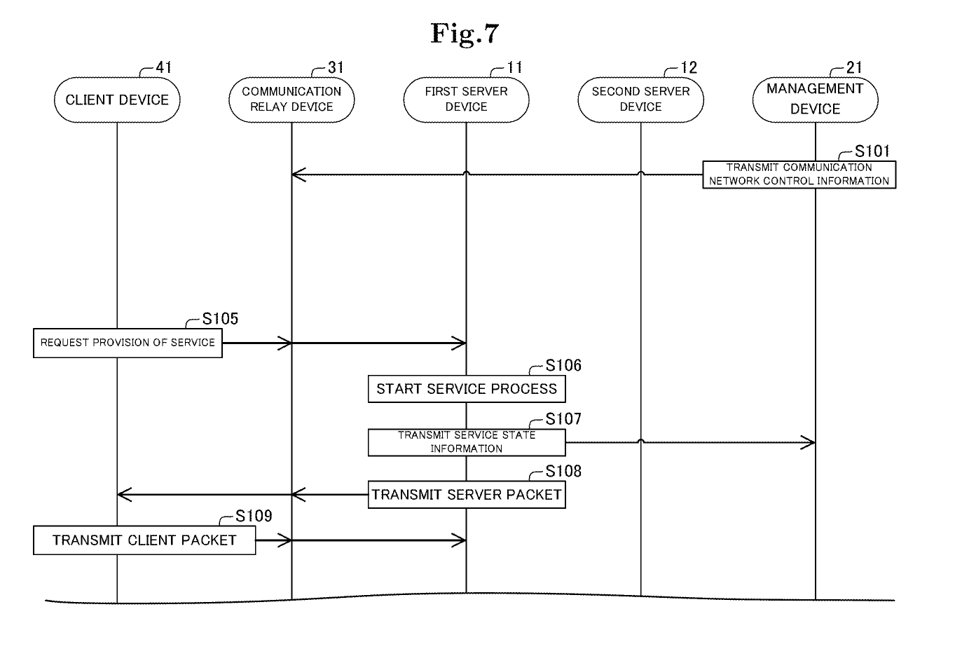

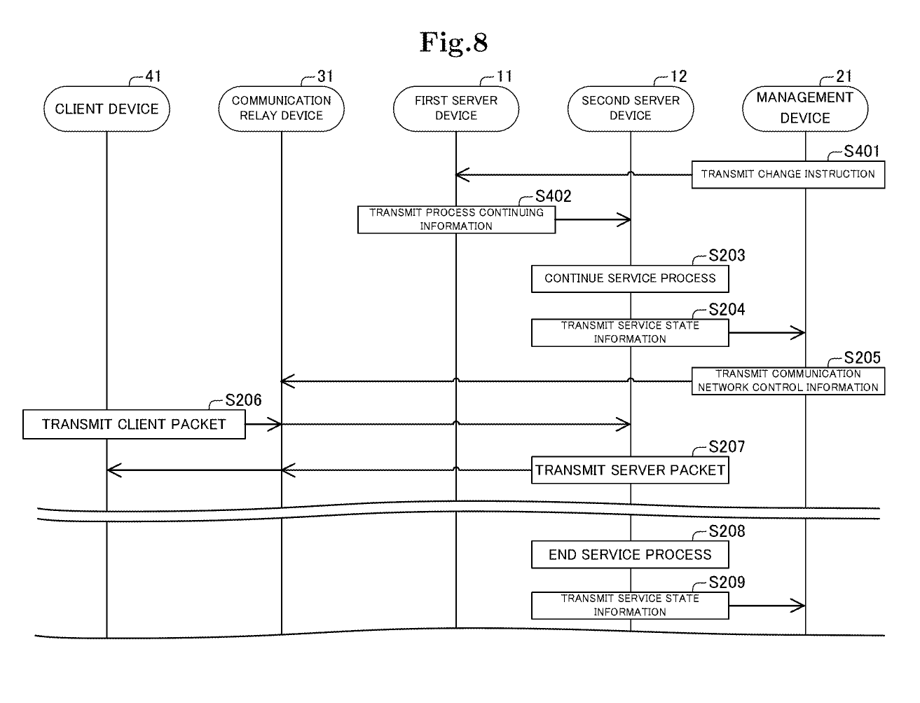

Next, the operation of the abovementioned communication system 1 will be described referring to FIGS. 7 and 8.

Firstly, as shown in FIG. 7, the communication system 1 according to the second exemplary embodiment executes a process in which steps S102 to S104 are excluded from the process shown in FIG. 5 executed by the communication system 1 according to the first exemplary embodiment.

A case where a preset change time and date comes afterward during execution of a service process by the first server device 11 will be assumed. In this case, the management device 21 transmits a change instruction to the first server device 11 (step S401 in FIG. 8). This change instruction contains change destination specification information for specifying the second server device 12.

Thus, the first server device 11 transmits process continuing information held thereby to the second server device 12 specified by the change destination specification information contained by the received change instruction (step S402 in FIG. 8).

Thus, the second server device 12 continues a service process that the first server device 11 has executed to provide a service to the client device 41, based on the process continuing information received thereby from the first server device 11 (step S203 in FIG. 8).

After that, as shown in FIG. 8, the communication system 1 according to the second exemplary embodiment executes the same process as in steps S204 to S209 shown in FIG. 6 executed by the communication system 1 according to the first exemplary embodiment (executes steps S204 to S209 in FIG. 8).

As described above, according to the communication system 1 of the second exemplary embodiment as well as the communication system 1 of the first exemplary embodiment, it is also possible, without changing the destination of a packet transmitted by the client device 41, to speedily change the server device 11, 12, . . . that the client device 41 exchanges packets.

Further, according to the communication system 1 of the second exemplary embodiment, it is possible to avoid that a load required to transmit process continuing information (e.g., a communication load, a processing load, etc.) is wastefully produced.

### Third Exemplary Embodiment

Next, a communication system according to a third exemplary embodiment of the present invention will be described. The communication system according to the third exemplary embodiment is different from the communication system according to the first exemplary embodiment in that the communication system according to the third exemplary embodiment is configured to stop or start the operation of a server device in accordance of a load on the server device. Therefore, a description will be made below focusing on the different point.

### (Configuration)

Each of the server devices 11, 12, . . . according to the third exemplary embodiment is configured to, when receiving an operation start instruction from the management device 21, start the operation of the device itself (in this exemplary embodiment, operation for executing a service process). Moreover, each of the server devices 11, 12, . . . is configured to stop the operation of the device itself when receiving an operation stop instruction from the management device 21. Each of the server devices 11, 12, . . . is configured to be capable of starting the operation of the device itself by receiving an operation start instruction even when the operation of the device itself is stopped.

### (Function)

The service management part 201 according to the third exemplary embodiment acquires a load on the operating server device 11, 12, . . . among the plurality of server devices 11, 12, . . . . In this exemplary embodiment, the service management part 201 acquires the load based on provision source specification information and provision destination specification information that are held thereby.

For example, the service management part 201 acquires the total number of the client devices 41, 42, . . . where a service is provided by the server device 11, 12, . . . , as the load. The service management part 201 may be configured to acquire a load-per-device on each of the server devices 11, 12, . . . in operation, and acquire the average value, the minimum value or the maximum value of the loads-per-devices as the loads on the server devices 11, 12, . . . in operation.

Further, in a case where the acquired load is higher than a preset threshold load (a first threshold load), the service management part 201 transmits an operation start instruction to the server device 11, 12, . . . under suspension so as to start the operation of the server device 11, 12, . . . under suspension.

Thus, it can be said that the service management part 201 configures an operation starting means which, in a case where part of the plurality of server devices 11, 12, . . . is under suspension and a load on the server device 11, 12, . . . in operation among the plurality of server devices 11, 12, . . . is higher than a preset threshold load, starts the operation of the server device 11, 12, . . . under suspension.

In addition, in a case where the load is higher than the first threshold load, the communication network management part 202 according to the third exemplary embodiment transmits communication network control information to each of the communication relay devices configuring the server communication network NW1 so as to set the server device 11, 12, . . . where an operation start instruction is to be transmitted, as the destination of transmission of a packet (a communication flow).

According to this, it is possible to distribute loads on the server devices 11, 12, . . . . Therefore, it is possible to avoid that loads on the server devices 11, 12, . . . become too large.

Further, in a case where the load is lower than a preset threshold load (a second threshold load), the communication network management part 202 transmits communication network control information to each of the communication relay devices configuring the server communication network NW1 so as to change the destination of transmission of a packet from a scheduled-to-stop device that is one of the server devices 11, 12, . . . in operation to the other server device 11, 12, . . . . In this exemplary embodiment, the second threshold load is set to a value which is lower than the first threshold load.

In addition, in a case where the load is lower than the second threshold load, the service management part 201 transmits an operation stop instruction to the scheduled-to-stop device so as to stop the operation of the scheduled-to-stop device.

Thus, it can be said that the service management part 201 configures an operation stopping means which stops the operation of a scheduled-to-stop device.

According to this, it is possible to reduce the number of the wastefully operating server devices 11, 12, . . . . Therefore, it is possible to reduce the amount of electric power consumed by the server devices 11, 12.

### (Operation)

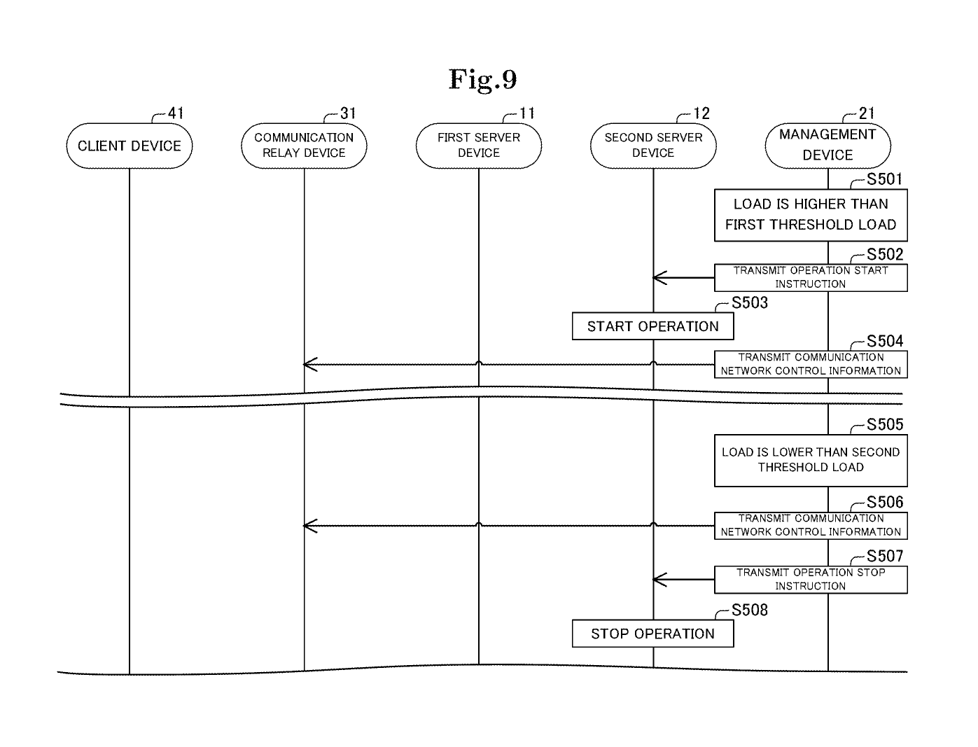

Next, the operation of the abovementioned communication system 1 will be described referring to FIG. 9.

In this exemplary embodiment, a case where the first server device 11 is operation and the second server device 12 is under suspension will be assumed.

In this case, the management device 21 transmits communication network control information to each of the communication relay devices 31 configuring the server communication network NW1 so as to set the first server device 11 as the destination of transmission of a packet in which the first IP address IP1 is set as the destination.

Further, the management device 21 transmits communication network control information to each of the communication relay devices 31 configuring the server communication network NW1 so as to set the first server device 11 as the destination of transmission of a packet in which the second IP address IP2 is set as the destination.

Thus, when receiving a packet with the first IP address IP1 set as the destination, each of the communication relay devices 31 configuring the server communication network NW1 transmits the packet to the first server device 11. Likewise, when receiving a packet with the second IP address IP2 set as the destination, each of the communication relay devices 31 configuring the server communication network NW1 also transmits the packet to the first server device 11.

A case where a load on the server device in operation (in this exemplary embodiment, the first server device 11) becomes higher than the first threshold load afterward will be assumed.

In this case, the management device 21 detects that the load is higher than the first threshold load (step S501 in FIG. 9). Then, the management device 21 transmits an operation start instruction to the second server device 12 so as to start the operation of the server device under suspension (in this exemplary embodiment, the second server device 12) (step S502 in FIG. 9).

Thus, the second server device 12 starts operation (step S503 in FIG. 9). Moreover, the management device 21 transmits communication network control information to each of the communication relay devices 31 configuring the server communication network NW1 so as to set the second server device 12 as the destination of transmission of a packet in which the second IP address IP2 is set as the destination (step S504 in FIG. 9).

As a result, a packet with the first IP address IP1 set as the destination is transmitted to the first server device 11. On the other hand, a packet with the second IP address IP2 set as the destination is transmitted to the second server device 12. Therefore, it is possible to distribute loads on the server devices 11, 12, . . . . Accordingly, it is possible to avoid a load on the server device 11, 12, . . . becomes too large.

A case where loads on the server devices in operation (in this exemplary embodiment, the first server device 11 and the second server device 12) become lower than the second threshold load afterward will be assumed.

In this case, the management device 21 detects that the loads are lower than the second threshold load (step S505 in FIG. 9).

Then, in this exemplary embodiment, the management device 21 specifies the second server device 12 as a scheduled-to-stop device. Therefore, the management device 21 transmits communication network control information to each of the communication relay devices 31 configuring the server communication network NW1 so as to set the first server device 11 as the destination of transmission of a packet in which the second IP address IP2 is set as the destination (step S506 in FIG. 9).

As a result, both a packet with the first IP address IP1 set as the destination and a packet with the second IP address IP2 set as the destination are transmitted to the first server device 11.

Next, the management device 21 transmits an operation stop instruction to the second server device 12 so as to stop the operation of the second server device 12 that is a scheduled-to-stop device (step S507 in FIG. 9). Thus, the second server device 12 stops operation (step S508 in FIG. 9). According to this, it is possible to reduce the number of the wastefully operating server devices 11, 12, . . . . Therefore, it is possible to reduce the amount of electric power consumed by the server devices 11, 12, . . . .

The communication system 1 according to the third exemplary embodiment includes both the functions of the operation starting means and the operation stopping means, but may include only one of the functions.

### Fourth Exemplary Embodiment

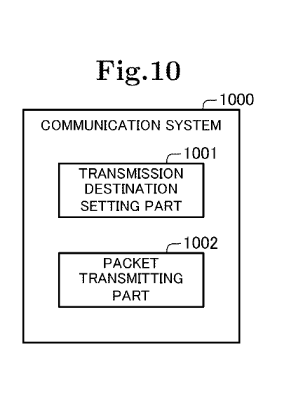

Next, a communication system according to a fourth exemplary embodiment of the present invention will be described referring to FIG. 10.

A communication system 1000 is a system including a plurality of information processing devices and a communication relay system relaying transmission of a packet between each of the plurality of information processing devices and an external device.

Moreover, at least one same IP address is assigned to each of the plurality of information processing devices.

Besides, the communication system 1000 includes a transmission destination setting part (a transmission destination setting means) 1001 configured to set one of the plurality of information processing devices, as the destination of transmission of a packet with the IP address set as a destination.

Moreover, the communication relay system includes a packet transferring part (a packet transferring means) 1002 configured to, when receiving a packet with the IP address set as a destination from the external device, transmit the received packet to the set destination of transmission.

According to this, it is possible to speedily change an information processing device which a packet with a certain IP address assigned to a plurality of information processing devices set as the destination reaches. Thus, without changing the destination of a packet transmitted by an external device, it is possible to speedily change an information processing device with which the external device exchanges packets. As a result, for example, without halting a service provided to an external device, it is possible to change an information processing device which provides the service.

Although the present invention is described above referring to the abovementioned exemplary embodiments, the present invention is not limited to the exemplary embodiments. The configurations and details of the present invention can be modified and changed in various manners that can be understood by one skilled in the art within the scope of the present invention.

For example, a program is stored in a storage device in each of the exemplary embodiments, but may be recorded on a computer-readable medium. For example, the recording medium is a portable medium such as a flexible disk, an optical disk, a magneto-optical disk, and a semiconductor memory.

Further, as other modified examples of the exemplary embodiments, any combinations of the abovementioned exemplary embodiments and modified examples may be employed.

### <Supplementary Notes>

The whole or part of the exemplary embodiments disclosed above can be described as, but not limited to, the following supplementary notes.

### (Supplementary Note 1)

A communication system including a plurality of information processing devices and a communication relay system relaying transmission of a packet between each of the plurality of information processing devices and an external device, at least one same IP address being assigned to each of the plurality of information processing devices,

the communication system including a transmission destination setting means for setting one of the plurality of information processing devices, as a destination of transmission of a packet with the IP address set as a destination,

wherein the communication relay system includes a packet transferring means for, when receiving a packet with the IP address set as a destination from the external device, transmitting the received packet to the set destination of transmission.

According to this, it is possible to speedily change an information processing device that a packet in which a certain IP address assigned to a plurality of information processing devices is set as the destination reaches. Thus, without changing the destination of a packet transmitted by an external device, it is possible to speedily change an information processing device with which the external device exchanges packets. As a result, for example, without halting a service provided to an external device, it is possible to change an information processing device that provides the service.

### (Supplementary Note 2)

The communication system according to Supplementary Note 1, wherein:

a plurality of different IP addresses are assigned to at least one of the plurality of information processing devices; and

the transmission destination setting means is configured to, for each of the plurality of IP addresses, set one of the information processing devices with the IP address assigned, as a destination of transmission of a packet with the IP address set as a destination.

According to this, it is possible to, for each of a plurality of IP addresses, appropriately transmit a packet with the IP address set as the destination to an information processing device.

### (Supplementary Note 3)

The communication system according to Supplementary Note 2, wherein the information processing device includes a response-time transmission source setting means for setting an IP address set as a destination of a packet received from the external device, as a source of transmission of a packet to be transmitted to the external device in response to the received packet.

According to this, it is possible to securely exchange packets between an external device and an information processing device. In other words, it is possible to appropriately perform communication between an external device and an information processing device.

### (Supplementary Note 4)

The communication system according to any of Supplementary Notes 1 to 3, including a process continuing information transmitting means for transmitting process continuing information from a first information processing device to a second information processing device, the process continuing information being information for continuing a process based on a packet transmitted between the first information processing device and the external device, the first information processing device being one of the plurality of information processing devices, and the second information processing device being another one of the plurality of information processing devices.

According to this, when the destination of transmission of a packet is changed from the first information processing device to the second information processing device, the second information processing device can continue to execute a process having been executed by the first information processing device. Therefore, for example, it is possible to avoid that a service provided from an information processing device to an external device is halted.

### (Supplementary Note 5)

The communication system according to Supplementary Note 4, wherein the process continuing information transmitting means is configured to transmit the process continuing information from the first information processing device to the second information processing device every time the process continuing information is changed or every time a preset update period passes.

According to this, even when a fault occurs in the first information processing device, the second information processing device can continue to execute a process having been executed by the first information processing device.

### (Supplementary Note 6)

The communication system according to Supplementary Note 4, wherein the process continuing information transmitting means is configured to transmit the process continuing information from the first information processing device to the second information processing device when the set destination of transmission of the packet is changed from the first information processing device to the second information processing device.

According to this, it is possible to avoid that a load (e.g., a communication load, and a processing load) required to transmit process continuing information is wastefully generated.

### (Supplementary Note 7)

The communication system according to any of Supplementary Notes 1 to 6, including an operation starting means for, in a case where part of the plurality of information processing devices is under suspension and a load on an information processing device in operation among the plurality of information processing devices is higher than a preset threshold load, causing an information processing device under suspension to start operation,

wherein the transmission destination setting means is configured to set the information processing device caused to start operation, as a destination of transmission of a packet with the IP address set as a destination.

According to this, it is possible to distribute a load on an information processing device. Therefore, it is possible to avoid that a load on an information processing device becomes too large.

### (Supplementary Note 8)

The communication system according to any of Supplementary Notes 1 to 7, wherein the transmission destination setting means is configured to, when a load on an information processing device in operation among the plurality of information processing devices becomes lower than a preset threshold load, change a destination of transmission of a packet with the IP address set as a destination from a scheduled-to-stop device to another information processing device, the scheduled-to-stop device being one of the information processing devices in operation,

the communication system including an operation stopping means for causing the scheduled-to-stop device to stop operation.

According to this, it is possible to reduce the number of wastefully operating information processing devices. Therefore, it is possible to reduce the amount of electric power consumed by an information processing device.

### (Supplementary Note 9)

A communication control method applied to a communication system including a plurality of information processing devices and a communication relay system relaying transmission of a packet between each of the plurality of information processing devices and an external device,

the communication control method including:

assigning at least one same IP address to each of the plurality of information processing devices; and

setting one of the plurality of information processing devices, as a destination of transmission of a packet with the IP address set as a destination,

wherein, when the communication relay system receives a packet with the IP address set as a destination from the external device, the communication relay system transmits the received packet to the set destination of transmission.

### (Supplementary Note 10)

The communication control method according to Supplementary Note 9, including:

assigning a plurality of different IP addresses to at least one of the plurality of information processing devices; and

for each of the plurality of IP addresses, setting one of the information processing devices with the IP address assigned, as a destination of transmission of a packet with the IP address set as a destination.

### (Supplementary Note 11)

The communication control method according to Supplementary Note 10, wherein the information processing device sets an IP address set as a destination of a packet received from the external device, as a source of transmission of a packet to be transmitted to the external device in response to the received packet.

### (Supplementary Note 12)

A communication relay system relaying transmission of a packet between each of a plurality of information processing devices and an external device, at least one same IP address being assigned to each of the plurality of information processing devices,

the communication relay system including:

a transmission destination setting means for setting one of the plurality of information processing devices, as a destination of transmission of a packet with the IP address set as a destination; and

a packet transferring means for, when receiving a packet with the IP address set as a destination from the external device, transmitting the received packet to the set destination of transmission.

### (Supplementary Note 13)

A communication relay control method applied to a communication relay system relaying transmission of a packet between each of a plurality of information processing devices and an external device,

the communication relay control method including:

assigning at least one same IP address to each of the plurality of information processing devices;

setting one of the plurality of information processing devices, as a destination of transmission of a packet with the IP address set as a destination; and

when receiving a packet with the IP address set as a destination from the external device, transmitting the received packet to the set destination of transmission.

### INDUSTRIAL APPLICABILITY

The present invention can be applied to, for example, a communication system which includes a plurality of information processing devices and a communication relay system relaying transmission of a packet between each of the information processing devices and an external device.

The present invention is based upon and claims the benefit of priority from Japanese patent application No. 2012-128746, filed on Jun. 6, 2012, the disclosure of which is incorporated herein in its entirety by reference.

### DESCRIPTION OF REFERENCE NUMERALS

1 communication system
11, 12 server device
21 management device
31 communication relay device
41, 42 client device
101 service processing part
102 data sharing part
103 service state information notifying part
201 service management part
202 communication network management part
203 fault monitoring part
301 transfer destination management part
302 packet transfer part
1000 communication system
1001 transmission destination setting part
1002 packet transmitting part
NW1 server communication network
NW2 client communication network

1. A communication system comprising a plurality of information processing devices and a communication relay system relaying transmission of a packet between each of the plurality of information processing devices and an external device, at least one same IP address being assigned to each of the plurality of information processing devices,
the communication system comprising a transmission destination setting unit for setting one of the plurality of information processing devices, as a destination of transmission of a packet with the IP address set as a destination,
wherein the communication relay system includes a packet transferring means unit for, when receiving a packet with the IP address set as a destination from the external device, transmitting the received packet to the set destination of transmission.

2. The communication system according to claim 1, wherein:
a plurality of different IP addresses are assigned to at least one of the plurality of information processing devices; and
the transmission destination setting unit is configured to, for each of the plurality of IP addresses, set one of the information processing devices with the IP address assigned, as a destination of transmission of a packet with the IP address set as a destination.

3. The communication system according to claim 2, wherein the information processing device includes a response-time transmission source setting unit for setting an IP address set as a destination of a packet received from the external device, as a source of transmission of a packet to be transmitted to the external device in response to the received packet.

4. The communication system according to claim 1, comprising a process continuing information transmitting unit for transmitting process continuing information from a first information processing device to a second information processing device, the process continuing information being information for continuing a process based on a packet transmitted between the first information processing device and the external device, the first information processing device being one of the plurality of information processing devices, and the second information processing device being another one of the plurality of information processing devices.

5. The communication system according to claim 4, wherein the process continuing information transmitting unit is configured to transmit the process continuing information from the first information processing device to the second information processing device every time the process continuing information is changed or every time a preset update period passes.

6. The communication system according to claim 4, wherein the process continuing information transmitting unit is configured to transmit the process continuing information from the first information processing device to the second information processing device when the set destination of transmission of the packet is changed from the first information processing device to the second information processing device.

7. The communication system according to claim 1, comprising an operation starting unit for, in a case where part of the plurality of information processing devices is under suspension and a load on an information processing device in operation among the plurality of information processing devices is higher than a preset threshold load, causing an information processing device under suspension to start operation,
wherein the transmission destination setting unit is configured to set the information processing device caused to start operation, as a destination of transmission of a packet with the IP address set as a destination.

8. The communication system according to claim 1, wherein the transmission destination setting unit is configured to, when a load on an information processing device in operation among the plurality of information processing devices becomes lower than a preset threshold load, change a destination of transmission of a packet with the IP address set as a destination from a scheduled-to-stop device to another information processing device, the scheduled-to-stop device being one of the information processing devices in operation,
the communication system comprising an operation stopping means unit for causing the scheduled-to-stop device to stop operation.

9. A communication control method applied to a communication system including a plurality of information processing devices and a communication relay system relaying transmission of a packet between each of the plurality of information processing devices and an external device,
the communication control method comprising:
assigning at least one same IP address to each of the plurality of information processing devices; and
setting one of the plurality of information processing devices, as a destination of transmission of a packet with the IP address set as a destination,
wherein, when the communication relay system receives a packet with the IP address set as a destination from the external device, the communication relay system transmits the received packet to the set destination of transmission.

10. The communication control method according to claim 9, comprising:
assigning a plurality of different IP addresses to at least one of the plurality of information processing devices; and
for each of the plurality of IP addresses, setting one of the information processing devices with the IP address assigned, as a destination of transmission of a packet with the IP address set as a destination.

11. The communication control method according to claim 10, wherein the information processing device sets an IP address set as a destination of a packet received from the external device, as a source of transmission of a packet to be transmitted to the external device in response to the received packet.

12. A communication relay system relaying transmission of a packet between each of a plurality of information processing devices and an external device, at least one same IP address being assigned to each of the plurality of information processing devices,
the communication relay system comprising:
a transmission destination setting unit for setting one of the plurality of information processing devices, as a destination of transmission of a packet with the IP address set as a destination; and
a packet transferring unit for, when receiving a packet with the IP address set as a destination from the external device, transmitting the received packet to the set destination of transmission.

13. A communication relay control method applied to a communication relay system relaying transmission of a packet between each of a plurality of information processing devices and an external device,
the communication relay control method comprising:
assigning at least one same IP address to each of the plurality of information processing devices;
setting one of the plurality of information processing devices, as a destination of transmission of a packet with the IP address set as a destination; and
when receiving a packet with the IP address set as a destination from the external device, transmitting the received packet to the set destination of transmission.
